(19) United States
(12) Patent Application Publication
(10) Pub. No.: US 2023/0286183 A1
(43) Pub. Date: Sep. 14, 2023

(54) Easy-Rinsing Razor Cartridge

(71) Applicant: Benjamin Avery, Oakland, CA (US)

(72) Inventor: Benjamin Avery, Oakland, CA (US)

(21) Appl. No.: 18/098,620

(22) Filed: Jan. 18, 2023

Related U.S. Application Data
(63) Continuation-in-part of application No. 17/181,857, filed on Feb. 22, 2021.

(51) Int. Cl. B26B 21/40

(52) U.S. Cl. CPC B26B 21/4031

(57) ABSTRACT

Described is a razor with a removable cartridge. The cartridge may attach to a handle magnetically or via another fastening technique, and may include a rigid mechanical structure that may not obstruct any water flowing through the cartridge when rinsing it. This may improve rinsing away clogs around the blades, hair, lotions, or other items, which may reduce the effectiveness of the razor and potentially lead to issues such as razor burns or razor rash.

### TECHNICAL FIELD

The instant disclosure relates to an easy-rinsing razor cartridge.

### BACKGROUND

The cartridge razor architecture has become very popular with consumers due to its ease of use in both shaving and replacing the cartridge when a fresh blade is needed. Today, a common practice for cartridge design in the industry is using a plastic structure into which steel blades are inserted. Unfortunately, these plastic structures often contain either mechanical rib features or appendages that can obstruct water flow to the blades, making rinsing out the blades inefficient and tedious for many consumers in their shaving routine.

### SUMMARY

The technology discussed herein relates to a device for shaving, including a handle and a cartridge containing at least one razor blade. The cartridge may comprise a rigid mechanical structure that blades can nest into while not obstructing any water flow to the blades needed to allow easier rinsability.

Having a razor that is not easy to rinse may lead to clogs around the blades, hair or lotions, or other items, which may reduce the effectiveness of the razor and potentially lead to issues such as razor burns or razor rash.

The cartridge may be fastened to the handle magnetically, using a pressure fit, or other fastening mechanisms, which may allow a cartridge design providing a large surface area to allow for easier rinsing than a cartridge using a structure such as mechanical supporting ribs to fasten the cartridge to a handle. A structure forming a perimeter of a long axis and a short axis of the blades may provide rigidity, reducing a need to create additional mechanical structures to ensure proper blade alignment. This may prevent flexing and warping in the blade area of the cartridge, which may be an issue for a traditional cartridge design.

### BRIEF DESCRIPTION OF THE DRAWINGS

FIG. 1 illustrates an example of a razor with water flowing through a cartridge for rinsing blades, according to one implementation.

FIG. 2 illustrates a top view of a cartridge according to one implementation.

FIG. 3 illustrates a top view of a cartridge according to another implementation.

FIG. 4 illustrates components of a razor, according to one embodiment.

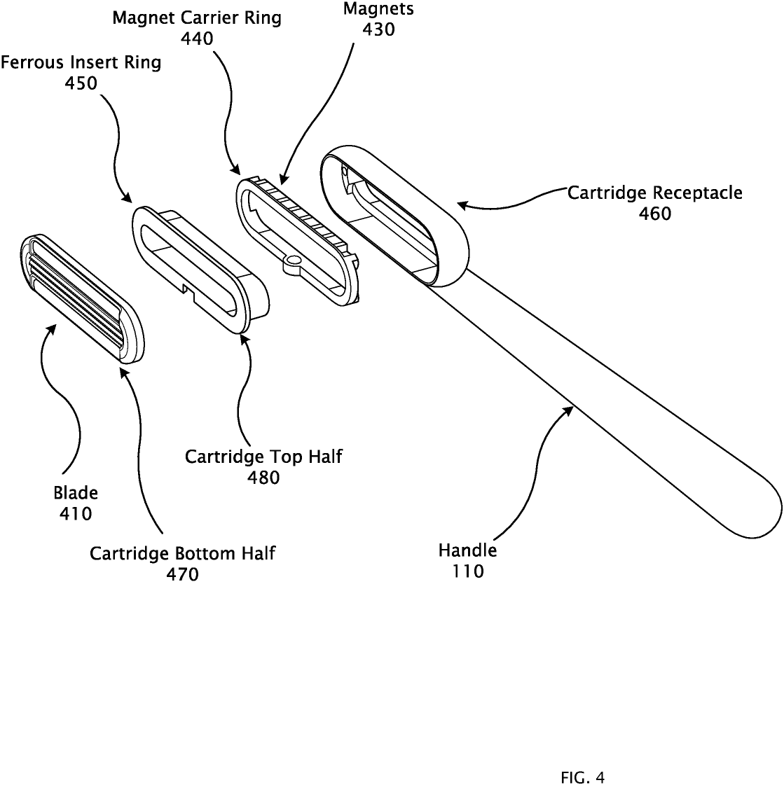

FIG. 5 illustrates a cross-section view of a cartridge according to one implementation.

### DETAILED DESCRIPTION

In the following detailed description, specific details are set forth by examples. However, it should be apparent to those skilled in the art that the instant disclosure is not so limited and that the instant disclosure includes modifications to the specific examples described herein without departing from the spirit and scope.

In one example, a razor or similar device is described that may include at least one razor blade or another sharp-edged component. The at least one razor blade may be used to remove hair from a skin surface. The at least one razor blade may be contained within a cartridge that may attach to a handle magnetically. After attaching the housing component or cartridge to the handle, a user may move the device by holding and moving the handle, thereby moving the attached housing component or cartridge and the razor blade(s) contained therein.

Using a magnetic fastening system may allow the cartridge to not require support structures covering an opening exposing the blades, which other fastening systems may require. This may allow a clear path for water through the blades to allow for better rinsing.

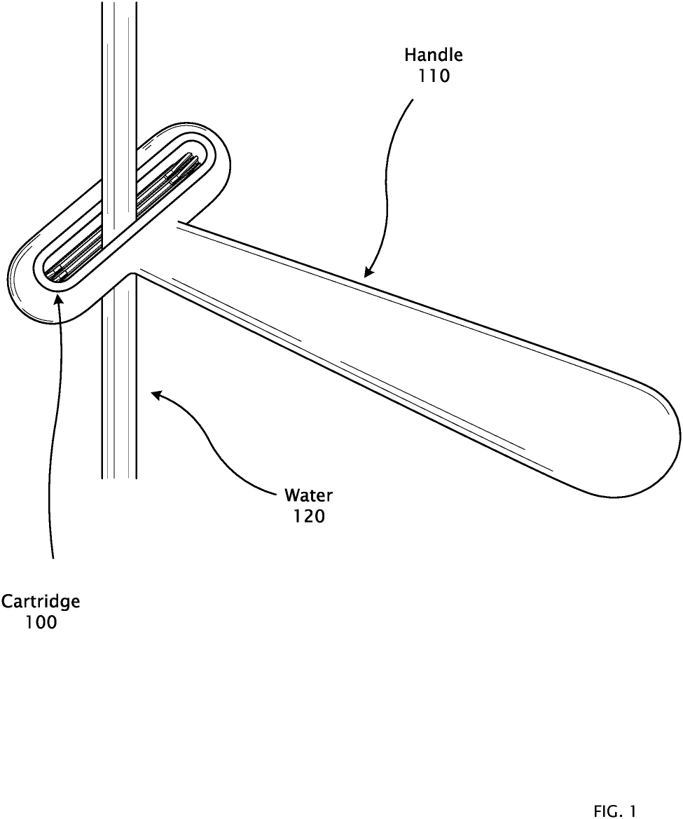

FIG. 1 illustrates an example of a razor with water flowing through Cartridge 100 for rinsing blades, according to one implementation. Cartridge 100 may attach magnetically to Handle 110, which may allow Cartridge 100 to permit Water 120 to flow through blades unobstructed.

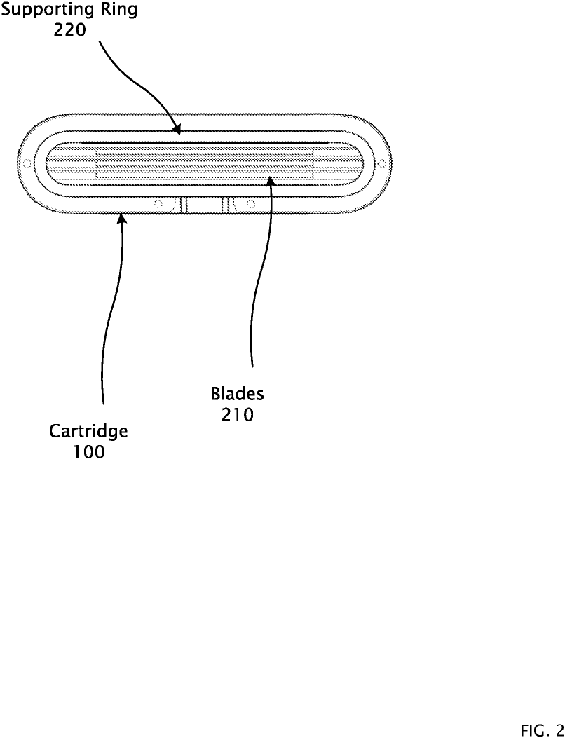

FIG. 2 illustrates a top view of Cartridge 100 according to one implementation. In this example, Cartridge 100 may contain at least one Blade 210. The at least one Blade 210 may contain a sharp edge on one aspect of Blade 210, such as a leading edge. The at least one Blade 210 may also contain a sharp edge on another aspect of Razor Blade 210, such as the trailing edge. Any aspect of Blade 210 may contain a sharp edge. In addition, Cartridge 100 may contain one Blade 210 or may contain a plurality of Blades 210 arranged in a variety of configurations. For example, the device may contain 2, 3, 5, or any number of Blades 210, which may be oriented with a sharp edge facing a side of Cartridge 100, for example, the front side of Cartridge 100. In the example illustrated in FIG. 2, Cartridge 100 contains multiple Blades 210 arranged in a parallel configuration. One of skill in the art would recognize that Blade 210, when arranged in a parallel configuration, may be spaced at various distances from each other while maintaining functionality. For example, two adjacent parallel Blades 210 may be positioned 0.5, 0.1, or 0.15 mm apart; however, any separating distance may be used to maintain desired functionality of the razor.

Supporting Ring 220 may be made of steel or another similar material, and may provide rigidity, which may reduce a need for extra supporting ribs.

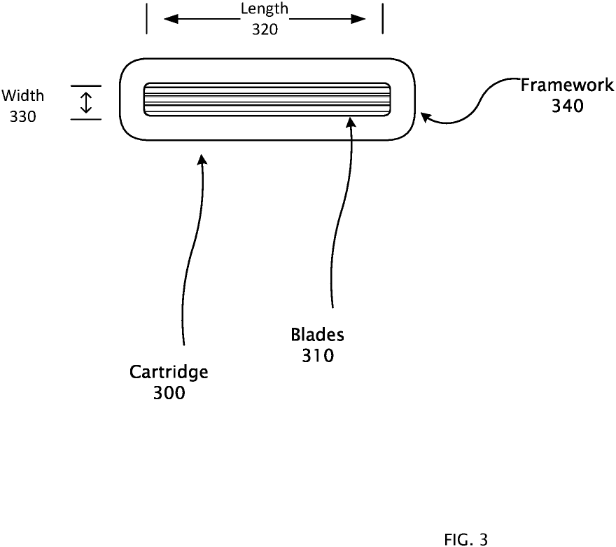

FIG. 3 illustrates a top view of a cartridge according to another implementation. In this example, Cartridge 300 may contain at least one Blade 310. The at least one Blade 310 may contain a sharp edge on one aspect of Blade 310, such as a leading edge. The at least one Blade 310 may also contain a sharp edge on another aspect of Razor Blade 310, such as the trailing edge. Any aspect of Blade 310 may contain a sharp edge. In addition, Cartridge 300 may contain one Blade 310 or may contain a plurality of Blades 310 arranged in a variety of configurations. For example, the device may contain 2, 3, 5, or any number of Blades 310, which may be oriented with a sharp edge facing a side of Cartridge 300, for example, a front side of Cartridge 300. In the example illustrated in FIG. 3, Cartridge 300 contains multiple Blades 310 arranged in a parallel configuration. One of skill in the art would recognize that Blades 310, when arranged in a parallel configuration, may be spaced at various distances from each other while maintaining functionality. For example, two adjacent parallel Blades 310 may be positioned 0.5, 0.1, or 0.15 mm apart; however, any separating distance may be used to maintain desired functionality of the razor.

Framework 340 may support Blades 310. Framework 340 may allow water to pass through Blades 310, as illustrated in FIG. 1 with Cartridge 100. Length 320 may be approximately 34 mm, and Width 330 may be approximately 4.5 mm, for example, which may provide an area sufficient for water to efficiently clean Blades 310. Having Blades 310 exposed with a range of 30 mm to 34 mm may allow Blades 310 to strengthen Cartridge 300, which may assist in reducing any requirement for structural ribs for Cartridge 300.

IG. 4 illustrates components of a razor, according to one embodiment. Cartridge Bottom Half 470 may contain one or more Blades 410 and may be attached to Cartridge Top Half 480. Magnet Carrier Ring 440 may comprise Magnets 430, which may removably couple to Ferrous Insert Ring 450 disposed on Cartridge Bottom Half 470.

Magnet Carrier Ring 440 may be fixed to Cartridge Receptacle 460, which may be part of Handle 110, to removably hold Cartridge 100 or 300 in place. Magnet Carrier Ring 440 may be provided that corresponds to a shape of Cartridge Receptacle 460. For example, if Cartridge Receptacle 460 is loop-shaped, Magnet Carrier Ring 440 may have a corresponding loop-shape such that Magnet Carrier Ring 440 may be inserted and fixed into loop-shaped Cartridge Receptacle 460. Alternatively, if Cartridge Receptacle 460 has a rounded rectangular shape, as Cartridge 300, Magnet Carrier Ring 440 may have a corresponding rounded rectangular shape such that Magnet Carrier Ring 440 may be inserted and fixed into rounded rectangular shaped Cartridge Receptacle 460. One having skill in the art will recognize that a magnet carrier ring and cartridge may have many different shapes.

In yet another example, at least one Magnets 430 may be contained within Cartridge Receptacle 460. For example, Cartridge Receptacle 460 may contain Magnets 430 on a front or leading side of Cartridge Receptacle 460 or Magnets 430 on a back or trailing side of Cartridge Receptacle 460. In a further example, Cartridge Receptacle 460 may alternatively or additionally contain Magnets 430 on at least one side edge of Cartridge Receptacle 460.

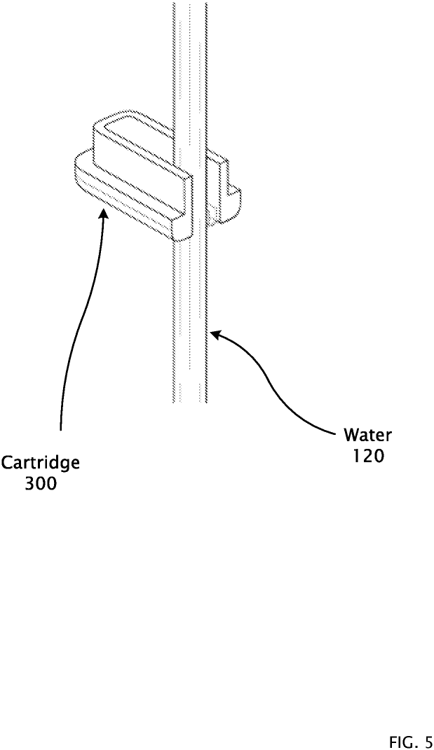

FIG. 5 illustrates a cross-section view of Cartridge 300 according to one implementation. Water 120 may flow through Cartridge 300 unimpeded to allow for easy rinsing of clogs around the blades, hair, lotions, or other items, which may reduce the effectiveness of the razor and potentially lead to issues such as razor burns or razor rash.

The foregoing description of various embodiments of the invention has been presented for the purposes of illustration and description. It is not intended to be exhaustive or to limit the invention to the precise form disclosed. It is intended that the scope of the invention be limited not by this detailed description, but rather by the claims appended hereto. The above specification, examples, and data provide a complete description of the manufacture and use of the invention. Since many embodiments of the invention can be made without departing from the spirit and scope of the invention, the invention resides in the claims hereinafter appended.

1. A cartridge for a razor, consisting of:
a plurality of blades;
a rigid mechanical structure comprising a perimeter framework holding the plurality of blades, the rigid mechanical structure not having any support covering an opening exposing the plurality of blades; and
a fastening means to couple the cartridge to a handle.
